(19) United States
(12) Patent Application Publication
(10) Pub. No.: US 2006/0202697 A1
(43) Pub. Date: Sep. 14, 2006

(54) Transmitter antenna

(76) Inventor: Audun Sodal, Ranheim (NO)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/565,725

(22) PCT Filed: Jul. 28, 2004
(86) PCT No.: PCT/GB04/03267

§ 371 Date: May 12, 2006

(30) Foreign Application Priority Data
Jul. 28, 2003 (GB) 03176492

(51) Int. Cl. G01V 3/00

(52) U.S. Cl. 324/332

(57) ABSTRACT

The present invention provides a transmitter antenna for use in Electromagnetic (EM) surveying beneath the ocean floor. The transmitter antenna according to the present invention comprises a current source and a dipole antenna, the dipole antenna comprising a first electrodes mounted on a cabled and located near to the current source and a second electrodes mounted on a cable and located further away from the current source, each electrode being electrically connected to the current source. The transmitter antenna may be deployed by being towed behind a vessel.

The present invention relates to a transmitter antenna for use in electromagnetic (EM) surveying beneath the ocean floor.

EM transmitter antennae are used to transmit low frequency ac current wave fields. The antennae may be deployed on an ocean floor but are generally towed behind a vessel as a cable or streamer.

It is an object of the present invention to provide a transmitter antenna which can be towed behind a vessel and which can provide a high current flow.

According to the present invention, there is provided an EM transmitter including a current source and a dipole antenna comprising a first electrode mounted on a cable and located near to the current source and a second electrode mounted on a cable and located further away from the current source, each electrode being electrically connected to the current source.

The electrodes may be mounted on the same cable but are preferably mounted on separate cables. The electrodes are preferably tubular or cylindrical and may be flush with the cable surface. They may be from 1 to 10 m in length, preferably 4 to 8 m eg. 6 m. They preferably have a metal outer surface such as copper or aluminium or rhodium or magnesium or platinum-plated titanium. The advantage of Pt-plated Ti is that it will tend not to be degraded by sea water and so the electrical properties will be more stable over time. The surface of the electrodes may be in the form of a grid and they may include buoyancy elements to render the electrodes neutral buoyant.

The electrodes are preferably spaced apart by a distance of between 100 and 1000 m, more preferably between 200 and 500 m, eg. about 250 to 300 m.

The cable is sufficiently flexible to be wound on to and off a storage drum and slightly buoyant at towing depths down to 3500 m. Slightly buoyant means the cable can later be trimmed in the field by adding small weights. The antenna cables will be trailed behind a towed body containing the high current source. The cable preferably includes a power conductor, sensor wires and/or optical fibres for communications and an insulating outer sheath. There is preferably also a buoyancy material which may be in the form of a gel to allow for the required flexibility. The power conductor is also arranged to allow flexibility and is preferably in a braided annular form. The cable may comprise interconnected sections which may be 50 to 100 m in length, preferably about 75 m. Alternatively, the cable may be continuous. The overall diameter of the cable is about 80 to 200 mm eg. about 120 mm. The two antenna cables could be attached together alongside in a towing configuration by some sort of clip-on or sliding collars.

The cable is preferably capable of generating a voltage sufficient to provide a current of 100 to 10,000 A, preferably 500 to 2000 A, eg. about 1000 A. The voltage maybe from 75 to 500V, preferably from 100 to 200V eg. 120V. Typically a voltage of up to 120V generates an AC current of up to 1000 A between the electrodes. The high current flow generates a low frequency electromagnetic field.

The cables m ay also include various sensors, such as depth transducers close to the two electrodes and one depth transducer and a temperatures sensor at the halfway point. The sensors may be positioned inside antenna cable and should be accessible for service in the field. An acoustic positioning transponder may be trailed from the antenna tail. The transponder can optionally be powered and triggered though the antenna cable. The sensors and command signals preferably communicates on an EM immune databus system.

In addition to being arranged two in line, the electrodes can be arranged in other configurations such as on the corners of a triangle or square.

The invention may be carried into practice in various ways and some embodiments will now be described by way of example with reference to the accompanying drawings in which:

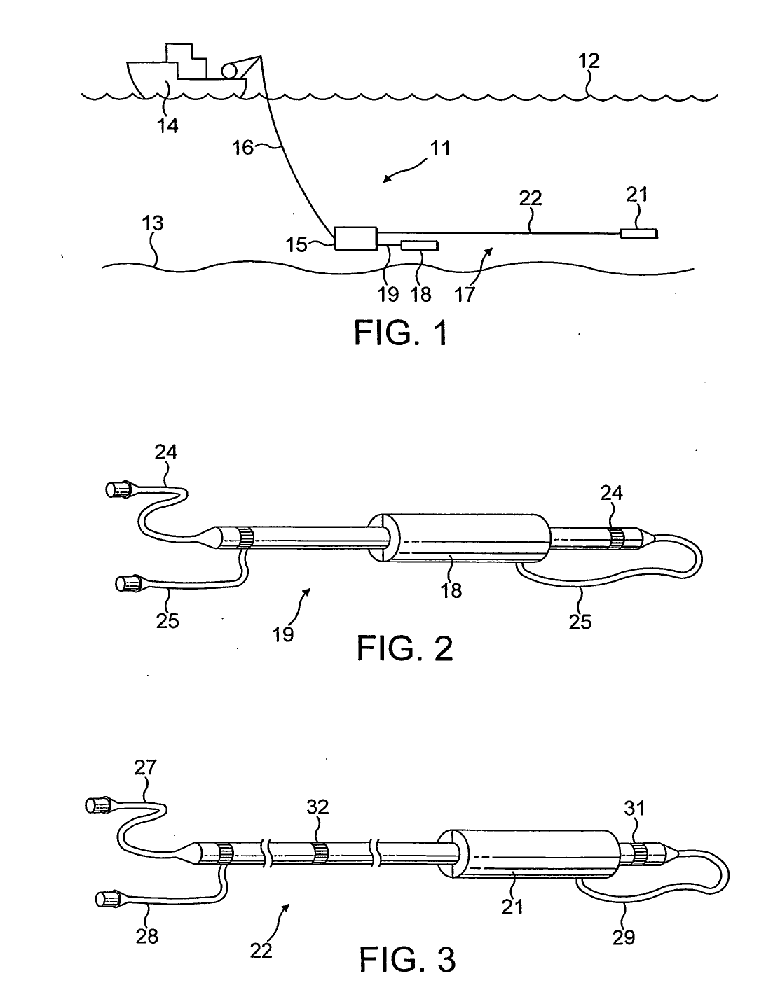

FIG. 1 is a schematic view of the transmitter antenna in use;

FIG. 2 is a schematic view of a front electrode;

FIG. 3 is a schematic view of a rear electrode;

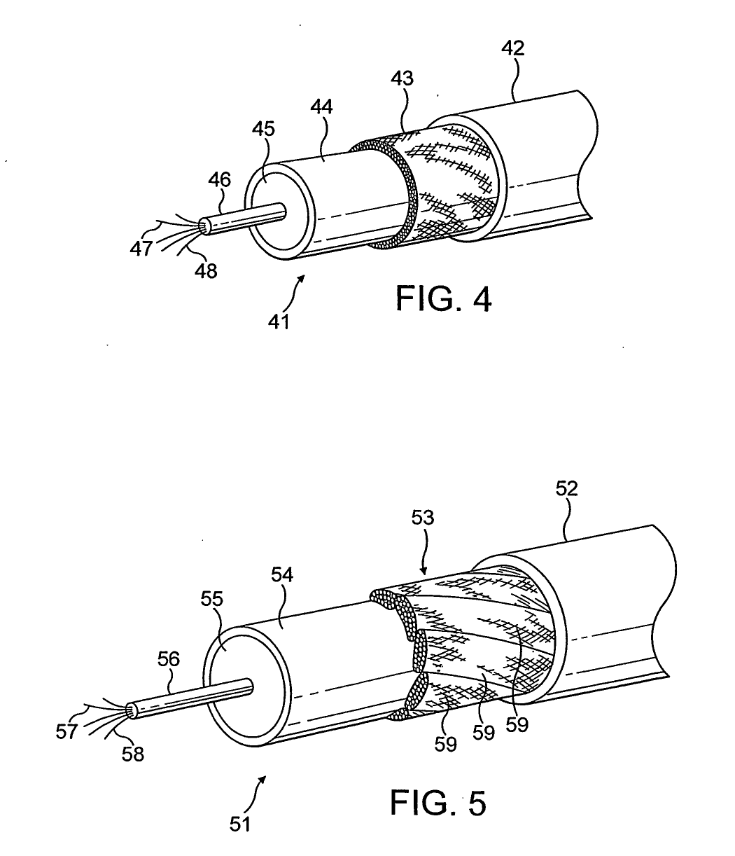

FIG. 4 is a cutaway view of one embodiment of a cable;

FIG. 5 is a cutaway view of a second embodiment of a cable.

FIG. 1 shows an EM transmitter 11 in use at a depth of about 3500 m below the ocean surface 12, just above the seabed 13. The transmitter 11 is towed by a surface vessel 14.

The transmitter 11 comprises a current source (not shown) located in a towing fish 15 connected to the vessel 14 by a line 16, and a dipole antenna 17. The antenna 17 comprises a front electrode 18 attached to the current source by a front cable 19 and a rear electrode 21 attached to the current source by a rear cable 22. The current source is capable of generating a voltage of 120V.

The front cable 19 is about 25 in length and is shown in more detail in FIG. 2. The front electrode 18 is 6 m long and is attached to the outside of the front cable 19. The rear cable 22 is about 300 m in length and is shown in more detail in FIG. 3. The rear electrode 21 is 6 m long and is attached to the outside of the rear cable 22. The two cables 19, 22 and electrodes 18, 21 have neutral buoyancy.

FIG. 2 shows the front cable 18 and front electrode 19. The front cable is about 25 m in length and carries the front electrode 19 towards the rear end. The electrode 19 is about 6 m long and made of a non-corrosive metal. The front cable 18 has a front depth sensor 23 at its rear end.

At its first end, the front cable 18 has a current connector 24 which is arranged to form a coupling with the current source in the fish 15 and a sensor connector 25 which forms a communications coupling with a control unit within the fish 15. The front depth sensor and any other sensors are connected to the sensor connector by means of a sensor conduit within the cable 18 as will be described in more detail below with reference to FIGS. 4 and 5.

At its rear end, the front cable 18 also has an electrode connector 26 which forms an electrical connection with the front electrode 19. The current connector 24 is connected to the electrode connector 26 by means of a conductor within the cable 18 as will be described in more detail below with reference to FIGS. 4 and 5.

The rear cable 22 and rear electrode 21 are similar to the front cable and electrode 19, 18, however, the rear electrode is about 300 m long. At the front, the rear cable has a current connector 27 and a sensor connector 28; at the rear it has an electrode connector 29 and a tail depth sensor 31. In addition, it has a centre depth sensor 32 about half way along its length.

Both electrodes 18, 21 include buoyancy devices (not shown) to render them substantially neutrally buoyant.

FIG. 4 shows the structure of the cable 41 used for the front and rear cables 19, 22, according to a first embodiment. The cable 41 comprises an outer insulating sheath 42, a conductor 43, an inner insulating sheath 44, a buoyancy gel 45 and a sensor conduit 46.

The outer sheath 42 is flexible, electrically insulating, water-impermeable and chemically stable in sea water. The conductor 43 is of braided copper wire and has a total transverse cross-sectional are of about 250 mm². The conductor 43 is connected at one end to the current connector 24, 27 and at its other end to the electrode connector 26, 29. In this way, the respective conductor passes current along its cable 19, 22 to the electrodes 18, 21.

The inner sheath 44 is flexible, water-impermeable and electrically insulating. The gel 45 is a buoyancy agent which is inherently flexible and is a known material in submarine cable technology. The sensor conduit 46 houses the necessary low power wires 47 and optical fibres 48 to establish communication between the various sensors such as the depth sensors 23, 31, 32 and the fish 15.

The second embodiment of cable 51 shown in FIG. 5 is similar to the cable 41 in all respects except for the conductor 53. It comprises an outer sheath 52, a conductor 53, an inner sheath 54, a gel 55 and a sensor conduit 56 with wires 47 and optical fibres 48. However, in this embodiment, the conductor 53 is made up of tapes 59 of braided copper wire which are wound around the inner sheath 54. Again, the transverse cross-sectional area of the conductor 53 is about 250 mm².

1. An EM transmitters comprising a current source and a dipole antenna, the dipole antenna comprising a first electrodes mounted on a cabled and located near to the current source and a second electrodes mounted on a cable and located further away from the current source, each electrode being electrically connected to the current source.

2. An EM transmitter as claimed in claim 1, wherein the electrodes are mounted on different cables.

3. An EM transmitter as claimed in claim 1, wherein the electrodes are spatially arranged on the corners of a triangle or the corners of a square.

4. An EM transmitter as claimed in claim 1, wherein there are two electrodes arranged in line.

5. An EM transmitter as claimed claim 1, wherein the outer surface of the electrodes is formed from a non-corrosive metal.

6. An EM transmitter as claimed in claim 5, wherein the metal is copper or aluminium or platinum-plated titanium, or rhodium or magnesium.

7. An EM transmitter as claimed in claim 1, wherein the electrodes are tubular.

8. An EM transmitter as claimed in claim 1, wherein the electrodes are cylindrical.

9. An EM transmitter as claimed in claim 1, wherein the electrodes lie flush with the cable surface.

10. An EM transmitter as claimed in claim 1, wherein the surface of the electrodes is in the form of a grid.

11. An EM transmitter as claimed in claim 1, wherein the electrodes further comprise buoyancy elements to render the electrodes neutral buoyant.

12. An EM transmitter as claimed in claim 1, wherein the electrodes are between 1 m and 10 m in length.

13. An EM transmitter as claimed in claim 12, wherein the electrodes are between 4 m and 8 m in length.

14. An EM transmitter as claimed in claim 13, wherein the electrodes are 6 m in length.

15. An EM transmitter as claimed in claim 1, wherein the electrodes are spaced apart by a distance of between 100 m and 1000 m.

16. An EM transmitter as claimed in claim 15, wherein the electrodes are spaced apart by a distance of between 200 m and 500 m.

17. An EM transmitter as claimed in claim 16, wherein the electrodes are spaced apart by a distance of between 250 m and 300 m.

18. An EM transmitter as claimed in claim 1, wherein each cable comprises a power conductors and an electrically insulating outer sheath and is connected to a body containing the current source.

19. An EM transmitter as claimed in claim 18, wherein the power conductor is in a braided annular form.

20. An EM transmitter as claimed in claim 19, wherein the electrically insulating outer sheath is water-impermeable and chemically stable in sea water.

21. An EM transmitter as claimed in claim 1, wherein each cable is sufficiently flexible to be wound on a storage drum.

22. An EM transmitter as claimed in claim 1, wherein each cable further comprises either sensor wires or optical fibres or both.

23. An EM transmitter as claimed in claim 1, wherein each cable further comprises depth transducer close to the electrodes and a temperature sensor and a further depth transducer located at the halfway point of the cable.

24. An EM transmitter as claimed in claim 1, wherein each cable comprises buoyancy elements imparting slight buoyancy to towing depths of 3500 m.

25. An EM transmitter as claimed in claim 18, wherein each cable continuous.

26. An EM transmitter as claimed in claim 1, wherein each cable comprises interconnected sections being between 50 m and 100 m in length, preferably 75 m.

27. An EM transmitter as claimed in claim 1, wherein the overall diameter of each cable between 80 mm and 200 mm, preferably 120 mm.

28. An EM transmitter as claimed in claim 1, wherein each cable arranged to generate a voltage sufficient to provide a current of 100 A to 10,000 A.

29. An EM transmitter as claimed in claim 28, wherein each cable is preferably arranged to generate a voltage sufficient to provide a current of 500 A to 2000 A.

30. An EM transmitter as claimed in claim 29, wherein each cable is preferably arranged to generate a voltage sufficient to provide a current of 1000 A.

31. An EM transmitter as claimed in claim 1, further including an acoustic positioning transponder trailed from the antenna.

32. An EM transmitter as claimed in claim 1, further including an EM immune databus system, by means of which sensor and command signals are communicated.

33. A method of EM surveying beneath the ocean floor using an EM transmitter as claimed in claim 1, wherein the EM transmitter is deployed on the ocean floor.

34. A method of EM surveying beneath the ocean floor using an EM transmitter as claimed in claim 1, wherein the EM transmitter is deployed by towing behind a vessel as a cable or streamer.

35. A method of producing a survey report which comprises deploying a transmitter as claimed in claim 1, deploying one or more EM receivers; applying an EM wavefield to subsea strata using the EM transmitter; detecting the EM wavefield response using the EM receivers; analysing the EM wavefield response; and generating the survey report following the analysis.
